(19) United States
(12) Patent Application Publication
(10) Pub. No.: US 2016/0113235 A1
(43) Pub. Date: Apr. 28, 2016

(54) FOLDING PET URINE PAD CONVENIENT TO TAKE AS WELL AS PRODUCTION METHOD AND PROCESSING EQUIPMENT THEREOF

(71) Applicant: Jiangsu Zhongheng Pet Articles Joint-Stock Co., Ltd., Jiangsu (CN)

(72) Inventor: Qiu Bin, Jiangsu (CN)

(73) Assignee: Jiangsu Zhongheng Pet Articles Joint-Stock Co., Ltd., Jiangsu (CN)

(21) Appl. No.: 14/924,603

(22) Filed: Oct. 27, 2015

(30) Foreign Application Priority Data
Oct. 27, 2014 (CN) 201410577887.0

(51) Int. Cl. A01K 1/015

(52) U.S. Cl. CPC A01K 1/0157

(57) ABSTRACT

A folded pet urine pad convenient to carry includes multiple single pet urine pads, wherein the middle part of each single pet urine pad is folded, every two adjacent single pet urine pads are laminated in a staggered manner, and the lower half edge of the last single pet urine pad is pressed underneath the upper half edge of the next single pet urine pad.

### CROSS-REFERENCE TO RELATED APPLICATIONS

This Application claims priority of Chinese Patent Application No. CN201410577887.0, filed on Oct. 27, 2014, the disclosure of which is incorporated by reference in its entirety.

### TECHNICAL FIELD

The present invention relates to a folded pet urine pad convenient to carry as well as a production method and processing equipment thereof

### BACKGROUND ART

With the development of society and growth in the living standard, people also continually pursue spiritual life while enjoying material life, so more and more people yearn for natural ease, and keeping pets has gradually become a kind of popular fashion. In daily life, pet urine pads are generally used by people to clear excrements of pets. However, existing single pet urine pads are connected by breaking-point lines, directly folded and then put into packaging bags for package and use, and thus are not convenient to use and occupy a relatively large space since the storage function is not ideal in the use process, and therefore the aesthetic property of the household environment is affected. In order to solve such problems, technical staff of pet product manufacturing enterprises makes improvement on existing pet urine pad processing and production equipment.

### SUMMARY OF THE PRESENT INVENTION

The technical problem to be solved by the present invention is to provide a folded pet urine pad convenient to carry.

In order to solve said technical problem, the technical solution adopted by the present invention is as follows: the folded pet urine pad convenient to carry comprises multiple single pet urine pads, wherein the middle part of each single pet urine pad is folded, every two adjacent single pet urine pads are laminated in a staggered manner, and the lower half edge of the last single pet urine pad is pressed underneath the upper half edge of the next single pet urine pad.

The technical problem to be solved by the present invention is to provide a production method of the folded pet urine pad convenient to carry.

In order to solve such technical problem, the technical solution adopted by the present invention is as follows: the production method of the folded pet urine pad convenient to carry comprises the following steps: conveying the single pet urine pad produced by a pet urine pad processing main machine onto a receiving section at the front end of a lower conveying belt through a conveying device, laminating the former single pet urine pad entering the receiving section by the latter single pet urine pad entering the receiving section, conveying a laminated pet urine pad to folding devices for folding by cooperation of an upper conveying belt and the lower conveying belt, and stacking the folded folded pet urine pads convenient to carry into a receiving bucket on a pet urine pad processing main machine frame.

The technical problem to be solved by the present invention is to provide processing equipment of the folded pet urine pad convenient to carry

In order to solve said technical problem, the technical solution adopted by the present invention is as follows: the processing equipment of the folded pet urine pad convenient to carry comprises a pet urine pad processing main machine frame and a conveying device arranged on the pet urine pad processing main machine frame, wherein the upper conveying belt and the lower conveying belt which are matched to each other are arranged at the rear end of the pet urine pad processing main machine frame, the receiving section is arranged at the front end of the pet urine pad processing main machine frame, and folding devices are arranged on the pet urine pad processing main machine frame at the rear end of the upper conveying belt and the rear end of the lower conveying belt, respectively; and the single pet urine pad produced by the pet urine pad processing main machine is conveyed onto the receiving section at the front end of the lower conveying belt through the conveying device, the former single pet urine pad entering the receiving section is laminated by the latter single pet urine pad entering the receiving section, the laminated pet urine pad is conveyed to the folding devices for folding by cooperation of the upper conveying belt and the lower conveying belt, and the folded folded pet urine pads convenient to carry are stacked into the receiving bucket on the pet urine pad processing main machine frame.

In order to well solve said technical problem, the further technical solution adopted by the present invention is as follows: the structure of the folding devices comprises two folding rollers symmetrically arranged on the pet urine pad processing main machine frame through rotating shafts, respectively, and each of the two folding rollers is uniformly equipped with three triangular blades, respectively.

The present invention has the advantages that the folded pet urine pad convenient to carry as well as the production method and processing equipment thereof are high in production efficiency; the produced folded pet urine pad convenient to carry is convenient and efficient to use, occupies a small space and is convenient to draw, transport and store since the multiple independent single pet urine pads are sequentially laminated, folded and stored from top to bottom to form an integral body, and thus beautifies the household environment, keeps the household clean and tidy and alleviates the labor intensity of people.

### BRIEF DESCRIPTION OF THE DRAWINGS

FIG. 1 is a structural schematic diagram of the processing equipment in the folded pet urine pad convenient to carry as well as the production method and processing equipment thereof according to the present invention.

FIG. 2 is a structural schematic diagram of the folded pet urine pad convenient to carry in the pet urine pad convenient to carry as well as the production method and processing equipment thereof according to the present invention.

FIG. 3 is a structural schematic diagram when the folded pet urine pad convenient to carry in the folded pet urine pad convenient to carry as well as the production method and processing equipment thereof is placed in a urine pad packaging box according to the present invention.

In Figs.: the pet urine pad processing main machine frame 1, the conveying device 2, the upper conveying belt 3, the lower conveying belt 4, the receiving section 5, the folding device 6, the single pet urine pad 7, the laminated pet urine pad 8, the folded pet urine pad 9 convenient to carry, the receiving bucket 10, the rotating shaft 11, the folding roller 12, the triangular blade 13, the urine pad packaging box 14, the upper cover 15 and the pulling opening 14 are described.

### DETAILED DESCRIPTIONS

The specific content of the present invention is described in detail below in conjunction with the accompanying drawings and specific embodiments

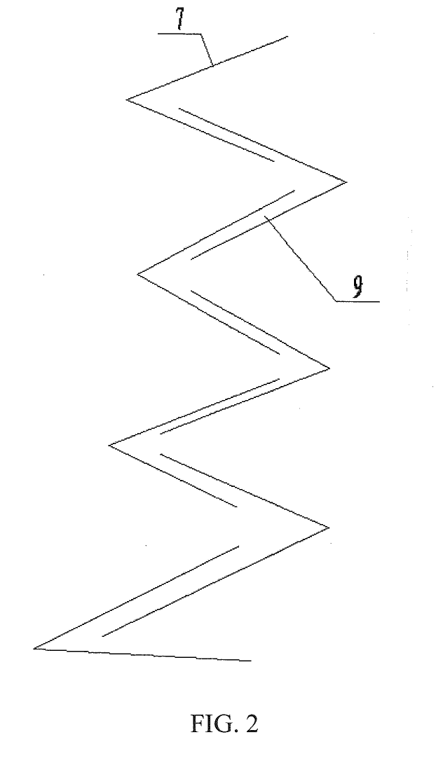

As can be seen from FIG. 2, the folded pet urine pad convenient to carry comprises multiple single pet urine pads 7, wherein the middle part of each single pet urine pad 7 is folded, every two adjacent single pet urine pads 7 are laminated in a staggered manner, and the lower half edge of the last single pet urine pad 7 is pressed underneath the upper half edge of the next single pet urine pad 7.

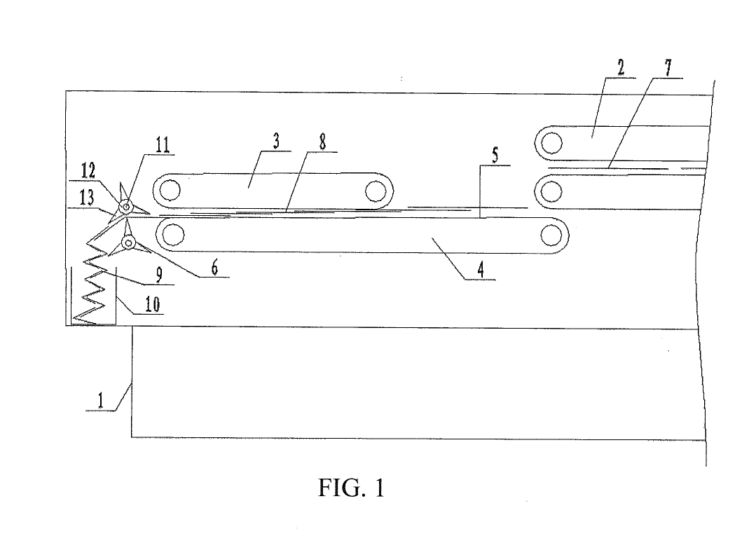

As can be seen from FIG. 1, the production method of the folded pet urine pad convenient to carry comprises the following steps: conveying the single pet urine pad 7 produced by the pet urine pad processing main machine onto the receiving section 5 at the front end of the lower conveying belt 4 through the conveying device 2, laminating the former single pet urine pad 7 entering the receiving section 5 by the latter single pet urine pad 7 entering the receiving section 5, conveying the laminated pet urine pad 8 to folding devices 6 for folding by cooperation of the upper conveying belt 3 and the lower conveying belt 4, and stacking the folded folded pet urine pad 9 convenient to carry into the receiving bucket 10 on the pet urine pad processing main machine frame 1.

As can be seen from FIG. 1, the processing equipment of the folded pet urine pad convenient to carry comprises the pet urine pad processing main machine frame 1 and the conveying device 2 arranged on the pet urine pad processing main machine frame 1, wherein the upper conveying belt 3 and the lower conveying belt 4 which are matched to each other are arranged at the rear end of the pet urine pad processing main machine frame 1, the receiving section 5 is arranged at the front end of the pet urine pad processing main machine frame, and the folding devices 6 are arranged on the pet urine pad processing main machine frame 1 at the rear end of the upper conveying belt 3 and the rear end of the lower conveying belt 4, respectively; and the single pet urine pad 7 produced by the pet urine pad processing main machine is conveyed onto the receiving section 5 at the front end of the lower conveying belt 4 through the conveying device 2, the former single pet urine pad 7 entering the receiving section 5 is laminated by the latter single pet urine pad 7 entering the receiving section 5, the laminated pet urine pad 8 is conveyed to the folding devices 6 for folding by cooperation of the upper conveying belt 3 and the lower conveying belt 4, and the folded folded pet urine pad 9 convenient to carry is stacked into the receiving bucket 10 on the pet urine pad processing main machine frame 1.

As can be seen from FIG. 1, the structure of the folding devices 6 comprises two folding rollers 12 symmetrically arranged on the pet urine pad processing main machine frame 1 through rotating shafts 11, respectively, and each of the two folding rollers 12 is uniformly equipped with three triangular blades 3, respectively.

As can be seen from FIG. 1, when the processing equipment of the folded pet urine pad convenient to carry is used, the single pet urine pad 7 produced by the pet urine pad processing main machine is conveyed onto the receiving section 5 at the front end of the lower conveying belt 4 through the conveying device 2, the former single pet urine pad 7 entering the receiving section 5 is laminated by the latter single pet urine pad 7 entering the receiving section 5, and the laminated pet urine pad 8 is conveyed to the folding devices 6 for folding by cooperation of the upper conveying belt 3 and the lower conveying belt 4; and as also can be seen from FIG. 1, the working principle of the folding devices 6 lies in that: when the laminated pet urine pad 8 enters a space between the two folding rollers 12, the rotating shafts 11 rotate under the driving of the driving device, the triangular blades 13 are configured to fold the laminated pet urine pad 8, and the folded folded pet urine pad 9 convenient to carry is stacked in the receiving bucket 10 on the pet urine pad processing main machine frame 1.

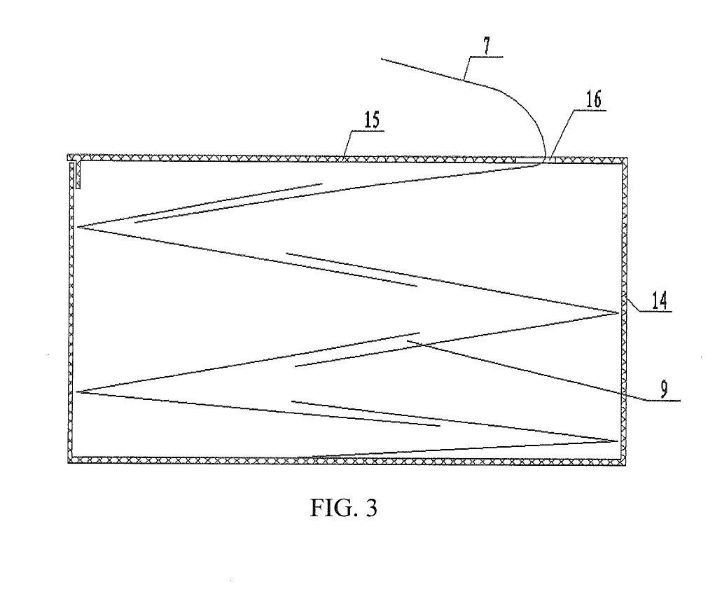

As can be seen from FIG. 2, the folded pet urine pad 9 convenient to carry consists of multiple single pet urine pads 7; and as can be seen from FIG. 3, the folded pet urine pad 9 convenient to carry is put in the urine pad package box 14, wherein the upper cover 15 is arranged on the upper end of the urine pad package box 14, and a pulling opening 16 from which the single urine pad 7 is drawn out is formed in the middle of the upper cover 15.

The folded pet urine pad convenient to carry as well as the production method and processing equipment thereof are high in production efficiency; the produced folded pet urine pad convenient to carry is convenient and efficient to use, occupies a small space and is convenient to draw, transport and store since the multiple independent single pet urine pads are sequentially laminated, folded and stored to form an integral body from top to bottom, and thus beautifies the household environment, keeps the household clean and tidy and alleviates the labor intensity of people.

What is claimed is:

1. A folded pet urine pad convenient to carry, comprising multiple single pet urine pads (7), wherein the middle part of each single pet urine pad (7) is folded, every two adjacent single pet urine pads (7) are laminated in a staggered manner, and the lower half edge of the last single pet urine pad (7) is pressed underneath the upper half edge of the next single pet urine pad (7).

2. A production method of the folded pet urine pad convenient to carry according to claim 1, comprising the following steps: conveying the single pet urine pad (7) produced by a pet urine pad processing main machine onto a receiving section (5) at the front end of a lower conveying belt (4) through a conveying device (2), laminating the former single pet urine pad (7) entering the receiving section (5) by the latter single pet urine pad (7) entering the receiving section (5), conveying a laminated pet urine pad (8) to a folding device (6) for folding by cooperation of an upper conveying belt (3) and the lower conveying belt (4), and stacking the folded folded pet urine pad (9) convenient to carry into a receiving bucket (10) on a pet urine pad processing main machine frame (1).

3. A processing equipment of the folded pet urine pad convenient to carry according to claim 1, comprising the pet urine pad processing main machine frame (1) and the conveying device (2) arranged on the pet urine pad processing main machine frame (1), wherein the upper conveying belt (3) and the lower conveying belt (4) which are matched to each other are arranged at the rear end of the pet urine pad processing main machine frame (1), the receiving section (5) is arranged at the front end of the pet urine pad processing main machine frame (1), and folding devices (6) are arranged on the pet urine pad processing main machine frame (1) at the rear end of the upper conveying belt (3) and the rear end of the lower conveying belt (4), respectively.

4. The processing equipment of the folded pet urine pad convenient to carry according to claim 3, wherein the structure of the folding devices (6) comprises two folding rollers (12) symmetrically arranged on the pet urine pad processing main machine frame (1) through rotating shafts (11), respectively, and each of the two folding rollers (12) is uniformly equipped with three triangular blades (13), respectively.
